(19) United States
(12) Patent Application Publication
(10) Pub. No.: US 2009/0110573 A1
(43) Pub. Date: Apr. 30, 2009

(54) Apparatus and Method for Retaining and Isolating Modular Fan and Motor Sub-Assemblies in Air Moving Systems

(76) Inventor: Robert A. Hoyt, Bristol, CT (US)

Correspondence Address: Haugen Law Firm PLLP, 1130 TCF Tower, 121 South Eighth Street, Minneapolis, MN, 55402, US

(21) Appl. No.: 12/257,780

(22) Filed: Oct. 24, 2008

Related U.S. Application Data
(60) Provisional application No. 61/000,616, filed on Oct. 26, 2007.

(51) Int. Cl. F04B 17/00; B23P 11/00; H02K 5/24

(52) U.S. Cl. 417/410.1; 29/428; 310/51

(57) ABSTRACT

An air moving system includes an outer housing including a plurality of housing portions, with a first of the housing portions being hingably securable to a second housing portion at a first pivot axis. The air moving system further includes a fan and motor sub-assembly that is operably disposed within the outer housing, and an isolator that is interposed between the outer housing and the sub-assembly, with the isolator being adapted to inhibit vibration transmission from the sub-assembly to the outer housing.

### CROSS-REFERENCE TO RELATED APPLICATIONS

This application claims priority to U.S. provisional patent application Ser. No. 61/000,616, filed on Oct. 26, 2007 and entitled “Retaining and Isolation Method for Modular Fan and Motor Sub-Assemblies”, the content of which being incorporated herein in its entirety.

### FIELD OF THE INVENTION

The present invention relates to air moving systems generally, and more particularly to housings for efficiently and economically securing fan and motor sub-assemblies with such air moving systems.

### BACKGROUND OF THE INVENTION

Typically, air moving systems, such as systems contained within computers or other electronic equipment for cooling purposes, contain a fan and motor sub-assembly secured within an aerodynamic element or housing. For example, the housings may be designed to improve and/or accelerate air flow through the air moving system so as to increase cooling efficiency. Conventional fan and motor sub-assemblies may be retained within their respective housings by snap or screw-type fasteners. Such fasteners, as well as conventional vibrational dampening components used in the assemblies, typically assume a significant volume, thereby requiring the air moving systems to be larger than necessary to accommodate the size of the fan and motor sub-assemblies. Moreover, conventional constructions involve excess parts, cost, and complexity in fabrication and assembly.

Accordingly, it is a primary object of the present invention to provide an air moving system assembly which eliminates the need for separate fasteners to secure a fan/motor sub-assembly to an outer housing.

It is another object of the present invention to provide an air moving system incorporating an outer housing that may be quickly assembled about a fan/motor sub-assembly without separate fastening components.

It is a further object of the present invention to provide an air moving system utilizing a relatively low-volume vibrational isolator which acts as an interface between a fan/motor sub-assembly and an outer housing.

### SUMMARY OF THE INVENTION

By means of the present invention, air moving systems may be fabricated and assembled in an efficient and cost-effective manner. The air moving systems of the present invention eliminate the need for separate fasteners to secure a fan/motor sub-assembly into an outer housing, and to assemble the outer housing itself about the fan/motor sub-assembly. Moreover, the air moving systems of the present invention may be reduced in overall volume while retaining and potentially increasing air throughput efficiency.

In one embodiment, the air moving system of the present invention includes an outer housing having a plurality of housing portions, with a first of said housing portions being hingeably securable to a second housing portion at a first pivot axis. The outer housing may further include a locking system for releasably securing the first housing portion to the second housing portion at a merge location that is circumaxially spaced from the first pivot axis. The air moving system further includes a fan and motor sub-assembly operably disposed within the outer housing, wherein the sub-assembly includes an outer surface profile that substantially corresponds to an inner surface of the outer housing. Moreover, the air moving system of the present invention includes an isolator interposed between the outer housing and the sub-assembly, wherein the isolator is adapted to inhibit vibration transmission to the outer housing. In one embodiment, an isolator for inhibiting vibration transmission from a fan/motor sub-assembly to an outer housing in an air moving system includes an elastic ring defining a first axis and having a first portion and a second portion together defining a substantially “L”-shaped cross-section. The elastic ring may further include a plurality of ribs circumaxially arranged about the elastic ring and extending from the first portion, which first portion is adapted to operably engage a substantially cylindrical outer side surface of the sub-assembly.

### BRIEF DESCRIPTION OF THE DRAWINGS

FIG. 1 is a perspective view of an air moving system of the present invention;

FIG. 2 is a schematic view of the air moving system illustrated in FIG. 1, with housing portions being separated;

FIG. 3A is a bottom view of the air moving system illustrated in FIG. 1;

FIG. 3B is an enlarged isolation view of a portion of the air moving system illustrated in FIG. 3A;

FIG. 4A is a cutaway side view of a portion of the air moving system illustrated in FIG. 1;

FIG. 4B is a cross-sectional view of a portion of the air moving system illustrated in FIG. 4A;

FIG. 5A is an enlarged isolation view of a portion of the air moving system illustrated in FIG. 1;

FIG. 5B is a schematic view of a portion of the air moving system illustrated in FIG. 5A; and

FIG. 5C is a schematic view of a portion of the air moving system illustrated in FIG. 5A.

### DETAILED DESCRIPTION FOR THE PREFERRED EMBODIMENTS

The objects and advantages enumerated above together with other objects, features, and advances represented by the present invention will now be presented in terms of detailed embodiments described with reference to the attached drawing figures which are intended to be representative of various possible embodiments of the invention. Other embodiments and aspects of the invention are recognized as being within the grasp of those having ordinary skill in the art.

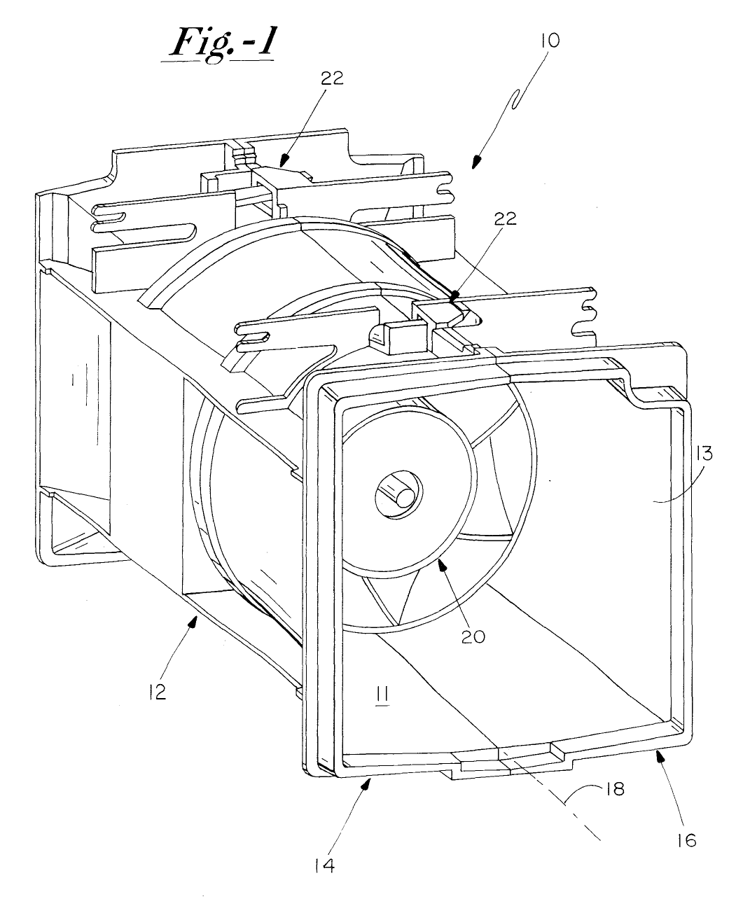

With reference now to the drawings, and first to FIG. 1, a modular air moving system 10 includes an outer housing 12 having first and second housing portions 14, 16. In some embodiments, first and second portions 14, 16 are separate components that may be hingedly secured to one another at a first pivot axis 18 so as to be enclosable about fan and motor sub-assembly 20. In addition, outer housing 12 may include a locking feature, such as locking systems 22, 22 for releasably securing first housing portion 14 to second housing portion 16 in a closed condition about sub-assembly 20.

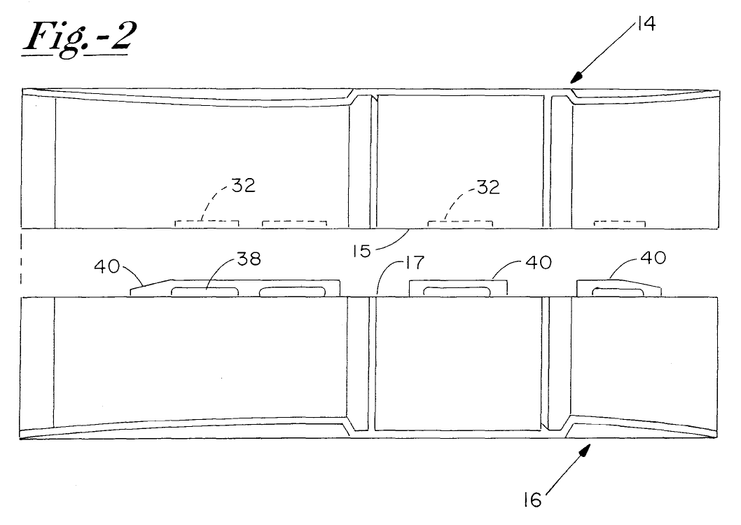

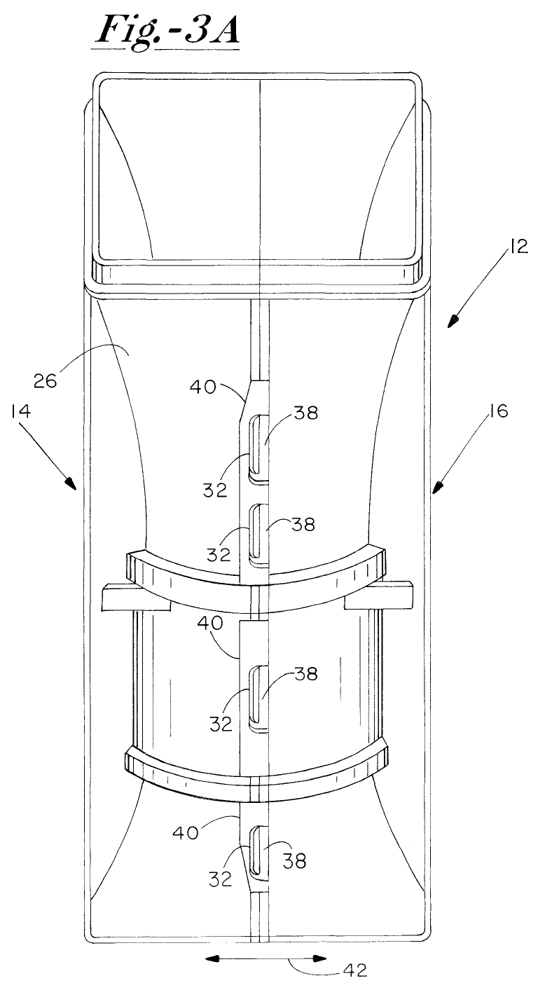

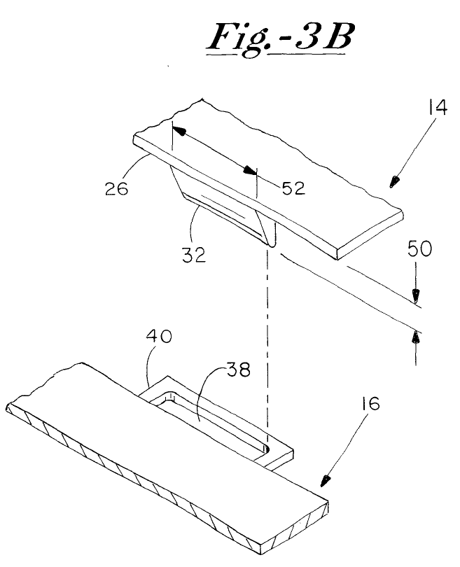

As illustrated in FIG. 2, first and second housing portions 14, 16 may hingeldy pivot about first pivot axis 18 in a “clamshell” arrangement to operably enclose fan/motor sub-assembly 20 within outer housing 12. In some embodiments, first and second housing portions 14, 16 are separate components having integral features that are hingedly engagable with one another to establish the hinge mechanism illustrated in FIG. 2. For example, and as illustrated in the bottom perspective view of FIG. 3A, first housing portion 14 may include one or more protrusions 32 extending from a lower surface 26 thereof. Such protrusions may be hingedly engagable in slots 38 defined by slot brackets 40 extending from second housing portion 16. An enlarged isolation view of this embodiment is illustrated in FIG. 3B, wherein protrusion 32 extends from lower surface 26 of first housing portion 14, while slot bracket 40 defining slot 38 extends from second housing portion 16. Protrusions 32 may be configured to operably pivot substantially about first pivot axis 18 within slot 38, while being retained in close proximity to second housing portion 16 by slot bracket 40. In particular, slot brackets 40 prevent relative separation movement by first and second housing portions 14, 16 along direction 42. It is contemplated that the operable enclosure of fan/motor sub-assembly 20 within outer housing 12 further assists in generating retention forces at the engagement of protrusions 32 within slots 38 defined by slot brackets 40.

In some embodiments of the present invention, one or both of protrusions 32 and slot brackets 40 are integrally formed with respective first and second housing portions 14,16. Such integration with the respective housing portions reduces fabrication cost in that such elements may be simultaneously molded with the remainder of the molded first and second housing portions 14,16. Moreover, the integral nature of protrusions 32 and slot brackets 40 reduces assembly time and cost by eliminating the need for multiple sequential fastening processes. In the illustrated embodiment, hingeable engagement between first and second housing portions 14, 16 may be accomplished in a single connective process, wherein all of protrusions 32 substantially simultaneously hingedly engage within respective slots 38 in a single step assembly process.

In one embodiment of the invention, protrusions 32 may have a height dimension 50 of between about 1 and about 5 millimeters, and a length dimension 52 of between about 5 and about 25 millimeters. Slot brackets 40 may be sized and configured to define slots 38 which accommodate one or more protrusions 32 therein. Other sizes and size relationships of protrusion 32 and slot bracket 40 are also contemplated as being useful in the present invention. Moreover, while the hinge characteristic of the engagement between first and second housing portions 14, 16 may be accomplished through the devices of the illustrated embodiment, such characteristic may also be accomplished through various other designs and configurations. Therefore, the protrusion and slot relationship described with reference to the illustrated embodiments are not intended to be limiting as to the various mechanisms for accomplishing hinged engagement between first and second housing portions 14, 16.

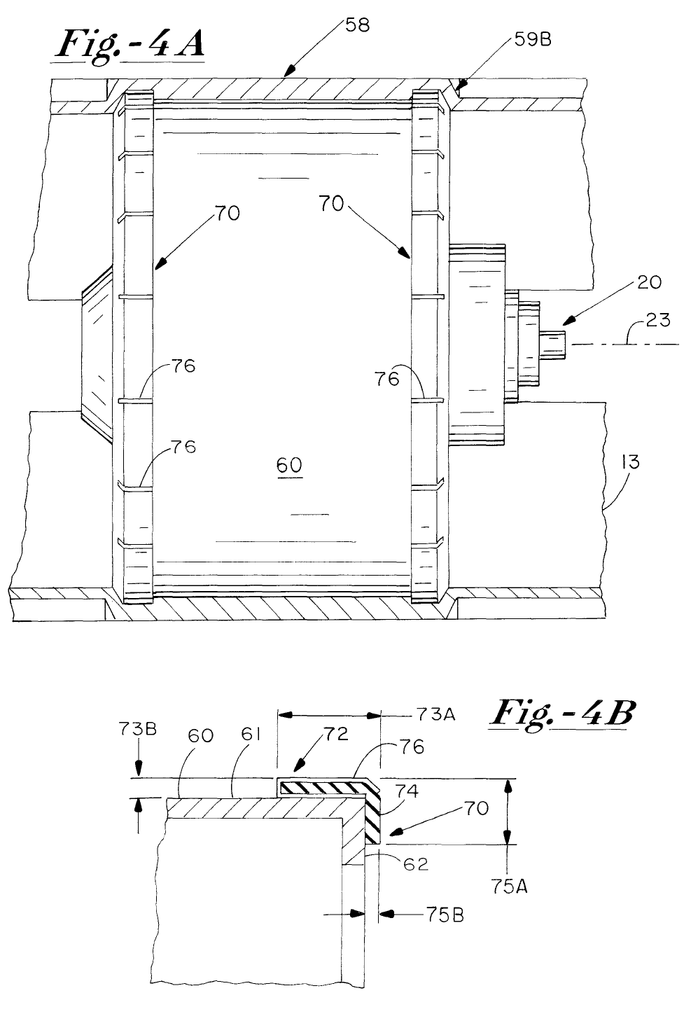

With reference to FIG. 4A, fan/motor sub-assembly 20 may be operably enclosable within the “clamshell” operation of outer housing 12. Fan/motor sub-assembly 20 may have a first outer surface 60 that is substantially cylindrical and circumaxially arranged about motor axis 23, which may be substantially parallel to first pivot axis 18. Sub-assembly 20 may preferably include at least some of the components necessary to instigate and maintain air flow through cavity 11 defined within outer housing 12. Such air movement may be directed by the orientation and contour of inner surface 13 of outer housing 12. In some applications, air flow driven through cavity 11 of outer housing 12 may be provided to assist in cooling heat-generating electronic components, such as those contained within computer systems.

Outer surface 60 of sub-assembly 20 may be configured to substantially correspond to inner surface 13 of outer housing 12. In the embodiment illustrated in FIG. 4A, inner surface 13 may be provided with a recessed section 58 having respective wall sections 59A, 59A that are configured to axially retain sub-assembly 20 in a fixed position within outer housing 12. To do so, wall sections 59A, 59B may be positioned to serve as an axial “stop point” for axial movement by sub-assembly 20. Such a configuration and contour for inner surface 13 of outer housing 12, however, is exemplary only, and a variety of other inner surface profiles may be used in connection with the apparatus of the present invention.

Isolators 70 may be provided as a means for inhibiting vibration transmission to outer housing 12. The operation of sub-assembly 20 can generate vibrations which can manifest into noise emitting from air moving system 10. In some cases, vibrations generated by the operation of sub-assembly 20 can result in damage to air moving system 10 over time, potentially degrading the performance of air moving system 10. While significant efforts are made to minimize vibration sources at sub-assembly 20, elimination of all such vibration has proven to be elusive. As a result, air moving systems typically employ a vibration dampening mechanism to reduce and inhibit vibration transmission from sub-assembly 20 to outer housing 12. Conventional vibration dampening systems, however, assume relatively large volumes and consequently add to the overall size of air moving system 10. In the continuing effort to reduce component sizes, and particularly in electronics applications, there is a need in the industry to provide a vibration dampening solution that minimizes volume requirements. Isolators 70 of the present invention provide such a solution, in that substantial vibration dampening is accomplished through the use of a relatively low-volume product.

In one embodiment, isolators 70 are substantially ring-shaped, and may be elastically secured about outer surface 60 of sub-assembly 20. Isolator 70 may be fabricated from a variety of materials to enable an elastic characteristic, with a particular example being elastomeric materials such as a PVC-based polymer available from EAR, Inc. under the trade name L-1002. Though isolator 70 may be provided in a ring configuration to substantially circumscribe outer surface 60 of sub-assembly 20, other configurations for isolators 70 are contemplated by the present invention. For example, an isolator 70 may be comprised of a plurality of distinct and separate portions that are placed at predetermined locations of sub-assembly 20 for effectuating the vibrational dampening characteristic described above.

In the illustrated embodiment, each isolator 70 defines a first center axis that, when isolator 70 is installed about sub-assembly 20, is substantially coextensive with motor axis 23. As illustrated in FIG. 4B, isolator 70 may be elastically retained at outer surface 60 of sub-assembly 20, wherein the elastic retention is accomplished by elastically “expanding” isolator 70 to fit about outer surface 60, such that residual contraction forces of isolator 70 frictionally hold isolator 70 in place at outer surface 60 of sub-assembly 20. To aid in such elastic retention, isolator 70 may have a cross section that is substantially “L” shaped, as shown in FIG. 4B. In such a configuration, first portion 72 of isolator 70 elastically engages side surface 61 of sub-assembly 20, while second portion 74 of isolator 70 elastically engages end surface 62 of sub-assembly 20. First and second portions 72, 74 of isolator 70 together define the substantially “L”-shaped cross-section of isolator 70. Second portion 74 of isolator 70 may be provided to assist in locating and securing isolator 70 in place about sub-assembly 20, and to prevent undesired migration of isolator 70 along side surface 61 of outer surface 60.

As further illustrated in FIGS. 4A and 4B, isolator 70 may include a plurality of ribs 76 circumaxially arranged about isolator 70 and extending from first portion 72 of isolator 70. In the illustrated embodiment, ribs 76 may extend radially outwardly and radially inwardly from first portion 72 with respect to motor axis 23, and may additionally extend laterally from first portion 72 along side surface 61 of sub-assembly 20. In effect, therefore, ribs 76 may substantially wrap about a portion of first portion 72 of isolator 70. In other embodiments, however, ribs 76 may be less extensive than that shown in the illustrated embodiments, and may, for example, extend only radially outwardly and/or radially inwardly from first portion 72 of isolator 70 with respect to motor axis 23. In some embodiments, ribs 76 may be substantially axially aligned in a parallel relationship to motor axis 23.

Ribs 76 may be provided at isolator 70 to further vibrationally isolate sub-assembly 20 from outer housing 12. In one embodiment, only ribs 76 interfacially contact both outer housing 12 and sub-assembly 20. It has been determined that a reduced contact surface area between sub-assembly 20 and outer housing 12 may reduce vibrational transmission to outer housing 12.

In one embodiment, first portion 72 of isolator 70 may have a width dimension 73A of between about 2 and about 10 mm, and a thickness dimension 73B of between about 0.25 and about 3 mm, while second portion 74 may have a width dimension 75A of between about 1 and about 6 mm, and a thickness dimension 75B of between about 0.25 and about 3 mm. Moreover, ribs 76 may have a thickness dimension of between about 0.05 and about 1 mm. These dimensions, however, are exemplary only, and it should be understood that isolator 70, as well as ribs 76, may assume a variety of dimensions, as desired per application. Preferably, however, isolator 70 is of relatively low volume, wherein the volumetric impact to the overall size of air moving system 10 due to the presence of isolator 70 is minimal.

In some embodiments, isolators 70 may provide both vibrational dampening by inhibiting vibration transmission from sub-assembly 20 to outer housing 12, and sealing engagement between sub-assembly 20 and outer housing 12. For example, isolators 70 may sealingly engage with wall sections 59A, 59B of inner surface 13 so as to prevent undesired air flow between sub-assembly 20 and outer housing 12. In one example, the sealing engagement provided by isolator 70 may inhibit or prevent air backflow around sub-assembly 20. As a result, air moving efficiency of air moving system 10 is enhanced.

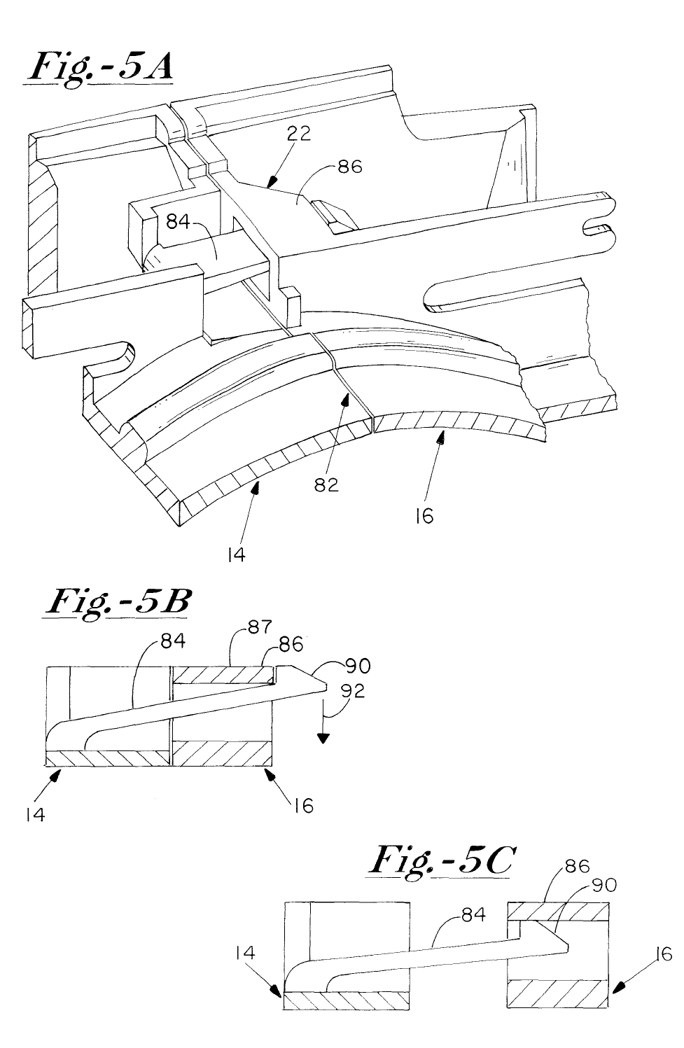

A further feature of the present invention is illustrated in FIGS. 5A-5C, wherein locking system 22 is adapted to releasably secure first housing portion 14 to second housing portion 16 at a merge location 82 that is circumaxially spaced from first pivot axis 18. In some embodiments, merge location 82 may be substantially coextensive along a substantial length of both first and second housing portions 14, 16. In other embodiments, however, merge location 82 may comprise only the location or locations at which locking system 22 releasably engages first housing portion 14 to second housing portion 16. In the illustrated embodiment, the “clamshell” housing design is enclosed about sub-assembly 20, with non-hinged edges 15, 17 of respective first and second housing portions 14, 16 being brought into juxtaposition with one another through the securing action of locking system 22.

In one embodiment, locking system 22 includes a male element 84 and a female element 86, wherein the male element 84 is engagable with female element 86. As illustrated in FIG. 5A, male element 84 is disposed at first housing portion 14, and female element 86 is disposed at second housing portion 16. In some embodiments, male and female elements 84, 86 are integrally formed with respective ones of first and second housing portions 14, 16.

As illustrated in FIGS. 5B and 5C, male element 84 may comprise a latch having a retention end 90 that operably engages upper wall 87 of female element 86 through a resilient action of male element 84. Such retention establishes the engagement between first housing portion 14 and second housing portion 16. To disengage first housing portion 14 from second housing portion 16, retention end 90 is depressed along direction 92 to separate retention end 90 from upper wall 87 of female element 86. While locking system 22 has been described with reference to a releasable latch as illustrated in FIG. 5A-5C, it is contemplated that a variety of releasable securement methods and devices may be utilized in connection with the air moving systems of the present invention.

The invention has been described herein in considerable detail in order to comply with the patent statutes, and to provide those skilled in the art with the information needed to apply the novel principles and to construct and use embodiments of the invention as required. However, it is to be understood that the invention can be carried out by specifically different embodiments and that various modifications can be accomplished without departing from the scope of the invention itself.

It is claimed that:

1. An air moving system, comprising:
(a) an outer housing including a plurality of housing portions, a first of said housing portions being hingeably securable to a second housing portion at a first pivot axis, and a locking system for releasably securing said first housing portion to said second housing portion at a merge location circumaxially spaced from said first pivot axis;
(b) a fan and motor sub-assembly operably disposed within said outer housing, said sub-assembly including an outer surface profile substantially corresponding to an inner surface of said outer housing; and
(c) an isolator interposed between said outer housing and said sub-assembly, said isolator being adapted to inhibit vibration transmission from said sub-assembly to said outer housing.

2. An air moving system as in claim 1, including protrusions extending from said first housing portion, said protrusions being hingeably engageable with receptacles in said second housing portion.

3. An air moving system as in claim 2 wherein said protrusions and receptacles are integrally formed with respective ones of said first and second housing portions.

4. An air moving system as in claim 1 wherein said locking feature includes a male element and a female element, said male element being disposed at said first housing portion, and said female element being disposed at said second housing portion.

5. An air moving system as in claim 4 wherein said male and female locking elements are integrally formed with respective ones of said first and second housing portions.

6. An air moving system as in claim 1 wherein said outer surface profile of said sub-assembly is substantially cylindrical.

7. An air moving system as in claim 1 wherein said isolator is in contact with both said outer surface of said sub-assembly and said inner surface of said outer housing.

8. An air moving system as in claim 1 wherein said isolator is elastomeric.

9. A method for securing a fan and motor sub-assembly of an air moving system within an aerodynamic outer housing, said method comprising:
(a) providing said outer housing with first and second portions defining a cavity there between and a hinge means integrally formed therewith and hingedly securing said first housing portion to said second housing portion, said hinge means defining a first pivot axis for pivoting motion of said first and second housing portions thereabout;
(b) positioning an isolator at an outer surface of said sub-assembly, said isolator being adapted to inhibit vibration transmission to said outer housing;
(c) positioning said sub-assembly in said cavity; and
(d) enclosing said sub-assembly within said outer housing such that said isolator is interposed between said outer housing and said sub-assembly.

10. A method as in claim 9 wherein said outer housing includes a locking means for releasably securing said first housing portion to said second housing portion in a closed condition for said outer housing.

11. A method as in claim 10 wherein said locking means is integrally formed with said outer housing.

12. A method as in claim 9 wherein said isolator is elastically secured about said sub-assembly.

13. A method as in claim 12 wherein said isolator is elastomeric.

14. An isolator for inhibiting vibration transmission from a fan/motor sub-assembly to an outer housing in an air moving system, said isolator comprising:
an elastic ring defining a first axis and having a first portion and a second portion together defining a substantially “L”-shaped cross-section, and a plurality of ribs circumaxially arranged about said elastic ring and extending from said first portion, wherein said first portion is adapted to operably engage a substantially cylindrical outer side surface of said sub-assembly.

15. An isolator as in claim 14 wherein said elastic ring is elastomeric.

16. An isolator as in claim 14 wherein said ribs are substantially axially aligned in a parallel relationship to said first axis.

17. An isolator as in claim 14 wherein said ribs extend radially outwardly from said first portion of said elastic ring.
